(19) United States
(12) Patent Application Publication
(10) Pub. No.: US 2009/0216493 A1
(43) Pub. Date: Aug. 27, 2009

(54) HIERARCHY OF DIAGNOSIS FOR ADVANCED DIAGNOSTICS EQUIPMENT

(76) Inventors: Olav M. Underdal, Kalamazoo, MI (US); Harry M. Gilbert, Portage, MI (US); Oleksiy Portyanko, Kalamazoo, MI (US); Randy L. Mayes, Otsego, MI (US); Gregory J. Fountain, Kalamazoo, MI (US); William W. Wittliff, III, Gobles, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/038,351

(22) Filed: Feb. 27, 2008

(51) Int. Cl. G06F 15/00

(52) U.S. Cl. 702/183

(57) ABSTRACT

A diagnostic tool for diagnosing a vehicle, includes a signal translator that communicates with the vehicle in at least one protocol, an input device that inputs information, a processor that controls a software according to the input information from the input device and communicates with the vehicle with the signal translator, the processor controls a reception of diagnostic data of the vehicle through the signal translator, the processor receives a selected instruction of the diagnostic tool through the input device and correlates the desired instruction information with the information stored in a memory, the processor processes the received diagnostic data according to the selected instructions information according to a hierarchy stored on the memory, the memory stores the software controlled by the processor, the memory stores a database of information for use by a hierarchical grouping of criteria and tests for diagnostics, the hierarchy including a first grouping and a second grouping, with each of the first and second grouping being further subdivided into additional sub-groupings, the selection of the diagnostic test being made according to the hierarchy from the most specific grouping to the most general grouping, executing through the processor the selected diagnostic test according to the hierarchy, and a display unit that receives and displays diagnostic information according to the selected stored and processed hierarchical information.

### TECHNICAL FIELD

The present disclosure relates generally to diagnostic equipment. More particularly, the present disclosure relates to a diagnostic hierarchy for use in a vehicle diagnostic tool.

### BACKGROUND OF THE DISCLOSURE

Onboard control computers have become prevalent in motor vehicles, but as safety, economy, and emissions requirements have continued to tighten, friction braking systems, and traction control devices have not met the requirements set out in government regulations and the implicit demands of competitors' achievements. Successive generations of onboard control computers have acquired increasing data sensing and retention capability as the electronics have advanced.

Present external diagnostic and display apparatus, known as diagnostic tools, are commonly limited to reporting the data acquired by the onboard control computer itself. Increasingly, subtle subsystem failures in vehicles overload the ability of maintenance technicians, not simply to read the faults detected and stored by the diagnostic tools themselves, but to combine those readings with peripheral measurements and deduce corrective actions with both speed and accuracy.

Currently in the automotive industry, there are both stand alone and hand-held diagnostic testers or tools used in connection with motor vehicle maintenance and repair. For example, hand-held diagnostic tools have been used to trouble-shoot faults associated with vehicular control units. Diagnostic tools can detect faults based on Diagnostic Trouble Codes or DTCs that are set in the vehicle's onboard control computer. A DTC can be triggered and stored when there is a problem with the vehicle. A technician then retrieves the DTC using a diagnostic tool, repairs the associated problem and then deletes the DTC from the vehicle's computer.

Including and beyond diagnostic trouble codes, in general, diagnostic systems are used by technicians and professionals in virtually all industries to perform basic and advanced system testing functions. For example, in the automotive, trucking, heavy equipment and aircraft industries, diagnostic test systems provide for vehicle onboard computer fault or trouble code display as mentioned above, interactive diagnostics, multiscope and multimeter functions, and electronic service manuals. In the medical industry, diagnostic systems provide for monitoring body functions and diagnosis of medical conditions, as well as system diagnostics to detect anomalies in the medical equipment.

In many industries, diagnostic systems play an increasingly important role in manufacturing processes, as well as in maintenance and repair throughout the lifetime of the equipment or product. Some diagnostic systems are based on personal computer technology and feature user-friendly, menu-driven diagnostic applications. These systems assist technicians and professionals at all levels in performing system diagnostics on a real-time basis.

A typical diagnostic system includes a display on which instructions for diagnostic procedures are displayed. The system also includes a system interface that allows the operator to view real-time operational feedback and diagnostic information. Thus, the operator may view, for example, vehicle engine speed in revolutions per minute, or battery voltage during start cranking; or a patient's heartbeat rate or blood pressure. With such a system, a relatively inexperienced operator may perform advanced diagnostic procedures and diagnose complex operational or medical problems.

The diagnostic procedures for diagnostic systems of this sort are typically developed by experienced technical experts or professionals. The technical expert or professional provides the technical experience and knowledge required to develop complex diagnostic procedures. Thus, the efficacy of the diagnostic procedures, in particular the sequence in which the diagnostic procedures are performed, is highly dependent on the expertise of the technical expert or professional authoring the procedures.

The diagnostic charts in existing systems are associated with groups of vehicles or vehicle systems usually by models, makes, years, etc. Such limitations have caused the necessity of creating the same type of diagnostic charts for different vehicle groups.

Therefore, there is a need to provide enhanced diagnostic hierarchy that eliminates the duplicates of diagnostic charts created by authors of diagnostic procedures. There is also the need to eliminate redundancy of data associated with diagnostic charts. Additionally, there is the need to reduce labor to create diagnostic scenarios. There is also a need to generalize diagnostic charts associating them with diagnostic and vehicle families and sub-families. Further, there is the need to reduce the complexity of lookup procedure during diagnostic runtime, etc.

### SUMMARY OF THE DISCLOSURE

The foregoing needs are met, to a great extent, by the present disclosure, wherein in one aspect a technique and apparatus are provided that will allow a technician to use a diagnostic system to determine the nature of a problem, with the ability to have a hierarchy of diagnosis.

In accordance with one aspect of the present disclosure, a diagnostic tool for diagnosing a vehicle, includes a signal translator that communicates with the vehicle in at least one protocol, an input device that inputs information, a processor that controls a software according to the input information from the input device and communicates with the vehicle with the signal translator, the processor controls a reception of diagnostic data of the vehicle through the signal translator, the processor receives a selected instruction of the diagnostic tool through the input device and correlates the desired instruction information with the information stored in a memory, the processor processes the received diagnostic data according to the selected instructions information according to a hierarchy stored on the memory, the memory stores the software controlled by the processor, the memory stores a database of information for use by a hierarchical grouping of criteria and tests for diagnostics, the hierarchy including a first grouping and a second grouping, with each of the first and second groupings being further subdivided into additional sub-groupings, the selection of the diagnostic test being made according to the hierarchy from the most specific grouping to the most general grouping, executing through the processor the selected diagnostic test according to the hierarchy, and a display unit that receives and displays diagnostic information according to the selected stored and processed hierarchical information.

The diagnostic tool can also have the first grouping including a diagnostic systems family and the second grouping including a vehicle family, the diagnostic systems family being grouped by the diagnostic function and the vehicle family being grouped by the type of vehicle. The diagnostic tool can also have diagnostic systems family being subdivided into a plurality of symptoms.

The diagnostic tool can also have the symptoms being further subdivided into a plurality of tests. The diagnostic tool can also have the symptoms being further subdivided into a plurality of failure mode tests according to a certain criteria. The diagnostic tool can also have any child of the first and second grouping inheriting the parent's diagnostics unless a limitation is made.

The diagnostic tool can also have the inheritance from parent grouping of the first group to child grouping. There can be at least two levels of symptom based on when whole symptom diagnostics are overridden, and a failure mode test based when some of the failure tests can be overridden, inherited or hidden. The diagnostic tool can also have the first grouping linked with the second grouping for diagnostic hierarchy of the vehicle. The diagnostic tool can also have a volatile memory unit and a non-volatile memory unit, the non-volatile memory unit storing the hierarchy information.

The diagnostic tool can also have the processor accepting a selection of the hierarchy according to the inputted selection. The diagnostic tool can also include the housing encasing the signal translator, the input device, an input and output unit, the processor, the memory, and the display unit for storing and processing the hierarchical information of a diagnostic procedure. The diagnostic tool can also include a connector interface that connects the signal translator with a vehicle interface through one of a wired and wireless link to allow for recording of the diagnostic data between the diagnostic tool and the vehicle.

In another aspect of the disclosure, a method of operating a diagnostic tool for a vehicle, includes linking the diagnostic tool with a diagnostic computer of the vehicle through a data link connector of the vehicle, communicating with the diagnostic computer of the vehicle in a communication protocol, receiving instruction with regard to a diagnostic procedure of the diagnostic tool and correlating with the stored information according to a hierarchy, grouping a first set of stored instructions into a first grouping and grouping a second set of stored instructions into a second grouping, subdividing the first and second grouping into a plurality of subgroups according to the hierarchy, selecting from the most specific subgroup to the most general group in determining the diagnostic test to be executed according to the hierarchy, and processing the received diagnostic data according to the hierarchy for execution and display of the diagnostics.

In another aspect of the disclosure, a diagnostic system for diagnosing a vehicle, includes a signal translation means that communicates with the vehicle in at least one protocol, an input means that inputs information, a processor means that controls a software according to the input information from the input device and communicates with the vehicle with the signal translator means, the processor means controls a reception of diagnostic data of the vehicle through the signal translation means, the processor means receives a selected instruction of the diagnostic tool through the input means and correlates the desired instruction information with the information stored in a memory means, the processor means processes the received diagnostic data according to the selected instructions information according to a hierarchy stored on the memory, the memory means stores the software controlled by the processor means, the memory means stores a database of information for use by a hierarchical grouping of criteria and tests for diagnostics, the hierarchy including a first grouping and a second grouping, with each of the first and second grouping being further subdivided into additional sub-groupings, the selection of the diagnostic test being made according to the hierarchy from the most specific grouping to the most general grouping, executing through the processor the selected diagnostic test according to the hierarchy, and a display means that receives and displays diagnostic information according to the selected stored and processed hierarchical information.

There has thus been outlined, rather broadly, certain embodiments of the disclosure in order that the detailed description thereof herein may be better understood, and in order that the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a front view illustrating a connection between a vehicle and a diagnostic tool or personal computer according to an embodiment of the disclosure.

FIG. 2 is a hierarchical diagram of the diagnostic system.

FIG. 3 is an example of the family tree for the vehicle.

FIG. 4 is an example of the database used by the diagnostic system.

FIG. 5 illustrates the use of specific data from the database of FIG. 4.

FIG. 6 is a block diagram of the computer of FIG. 1.

FIG. 7 is a front view of the diagnostic tool of FIG. 1.

FIG. 8 is a block diagram of the components of the diagnostic tool of FIG. 7.

### DETAILED DESCRIPTION

The disclosure will now be described with reference to the drawing figures, in which like reference numerals refer to like parts throughout. An embodiment in accordance with the present disclosure provides an apparatus and method that will allow a user, such as a technician, to use diagnostic equipment having a hierarchy of diagnosis to determine the nature of a problem. The diagnostic equipment can include, for example, but not limited to a diagnostic tool or a personal computer.

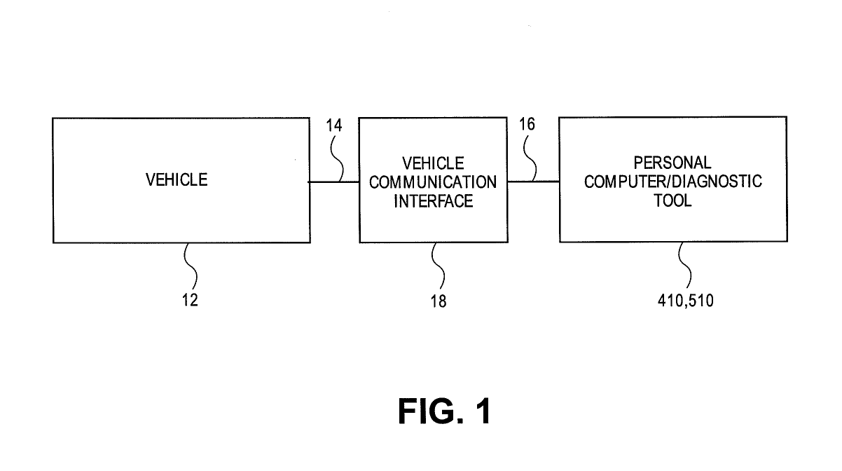

Referring to FIG. 1, a vehicle 12 is shown connected to a personal computer 410 or a dedicated diagnostic tool 510 via a vehicle communication interface 18. A first connection 14 between vehicle 12 and the vehicle communication interface 18, and a second connection 16 between the vehicle communication interface 18 and the personal computer/diagnostic tool 410 and 510 can be either wired or wireless.

Applicable communications with the host, such as a vehicle 12 connected to the diagnostic tool, can be maintained during all functions of the vehicle during diagnostics. The connections 14 and 16 can include a wired connection such as through a RS232 port, USB (Universal Serial Bus), or an Ethernet cable. However, the connections 14 and 16 can also be wireless using protocols such as BLUETOOTH, IEEE 802.11x, wireless USB, other types of wireless Ethernet protocols, etc.

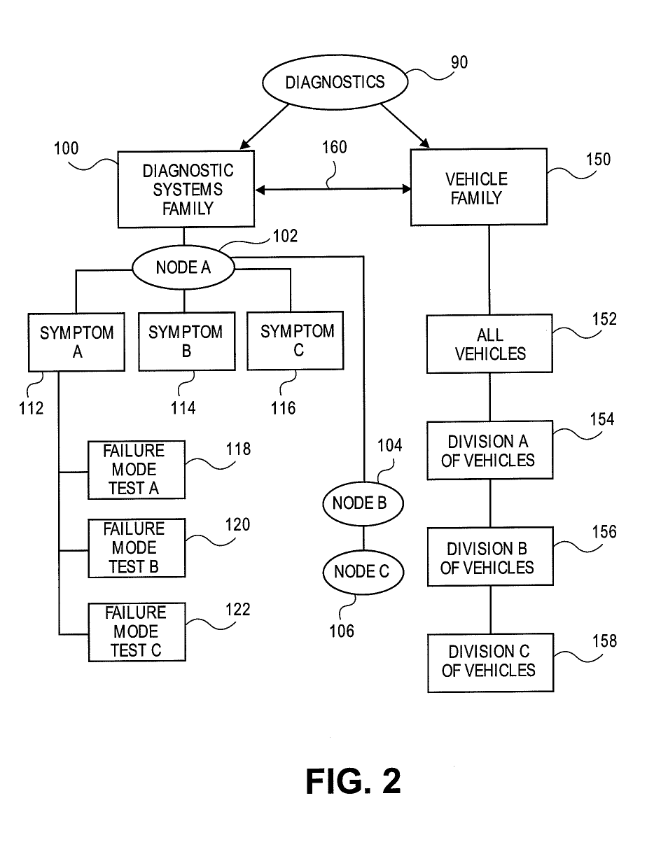

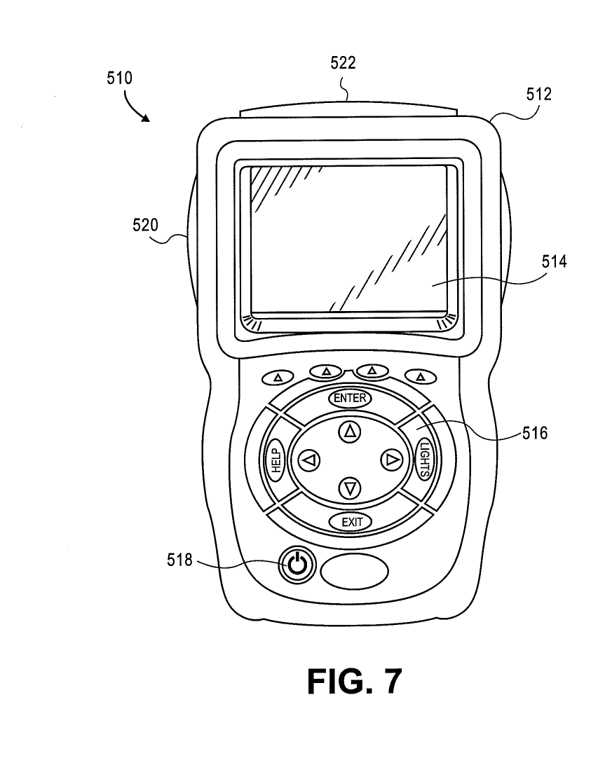

Referring to FIG. 2, the advanced diagnosis function hierarchy of the present disclosure includes at least two families, such as a diagnostic systems family tree 100 and a vehicle family tree 150. A user can select, for example, from a diagnostics menu 90 displayed on a display 514 (FIG. 7), whether to use the diagnostic systems family tree 100 or the vehicle family tree 150, or the selection can be automated, or the information between the two trees can be linked.

Each one of these families has a tree hierarchy as shown in FIG. 2. Each node 102-106 of diagnostic systems family includes the set of advanced diagnostic functions by symptoms. Three nodes, A through C are shown only as an example for the sake of clarification and more or less nodes may be used. Each node A through C 102-106 can be any set of criteria that is predetermined or set by the user.

The diagnostic systems family root nodes A through C 102-106 can include generic set of advanced diagnostic functions diagnostics, for example, but not limited to crank-no-start, stall, and any diagnostics that can be applied to any vehicle.

Alternatively as an example, node A 102 could be for the engine diagnostics or node B 104 could be for the electrical system or such division can be used instead for the vehicle family tree 150. A further branch can also be added to include a specific component of the electrical system. A different set of diagnostic criteria can also be selected. There is no limit as to the branching and subdividing of the criteria from general to more specific.

The nodes 102-106 are then divided into a set of symptoms A through C 112-116. The three symptoms are only shown as an example and there can be more or less symptoms. The symptoms can also be further subdivided.

Each advanced diagnostic function symptom diagnostic includes the set of failure mode tests (FM-Tests) according to FMEA (failure modes and effects analysis) technology. For example, symptom A 112 can be below acceptable limit for a voltage or resistance. In addition, for example, symptom A 112 can include failure mode test A 118, test B 120 and test C 122.

As mentioned above, the diagnostic systems family root node can include generic sets of advanced diagnostic functions diagnostics that can be applied to a vehicle. Any child node inherits all of the parent's diagnostics unless some or all diagnostics override, or hide the parent's ones, or have its own specific for this sub-family diagnostics. For example, if failure mode test A 118 is the child of parent symptom A 112, then it can inherit all of the parent's diagnostics, unless there is a restriction made. The restriction can be in the form of hiding the parent diagnostics or it may have its own specific diagnostic sets. The restriction can be predetermined or user defined and stored in the memory of the diagnostic tool.

There are at least two levels of inheritance: symptom-based when the whole symptom diagnostics are overridden, and FM-test based when some of the FM-Tests may be overridden, or inherited, or hidden. The diagnostic systems family tree can have any number of levels/families, but it always has the root node 102-106 that guarantees that runtime lookup will use the most generic diagnostic scenario if a specific one on any level is not found.

The vehicle family tree 150 is a flexible tree that allows the user to group vehicles by make, year, model, etc. When the vehicle family tree 150 is created, the user can associate 160 any vehicle sub-family with any diagnostic systems sub-family. The association can be made, for example, through a linking of the data or instructions from the vehicle family tree 150 with the diagnostic systems family tree 100.

For example, all year “n” vehicles are associated with year n diagnostics, except some model or models, or sub-model, or even vehicles with specific engine or engines are associated with some sub-family of year “n” diagnostics.

During runtime, after vehicle selection, the lookup procedure searches through vehicle family tree 150 starting from bottom vehicle-specific node 158 to the top of the tree 150 until the first association with the diagnostic system sub-family is found. For example, the vehicle family 150 can divided into all vehicles 152, and then divided into a division A 154, and then division B, and then finally division C 158 for the most specific grouping of the vehicles.

Then, it searches the symptom 112-116 through the diagnostic system tree 100 starting with found sub-family, such as node A 102, to the top of the tree. If an association is not found, the generic diagnostics are used. If symptoms are not found in diagnostic sub-family, the lookup procedure will look for it in the parent sub-family, etc. If the diagnostic sub-family is not found, the generic diagnostics are used. The process basically goes from the most specific set of criteria to the most general.

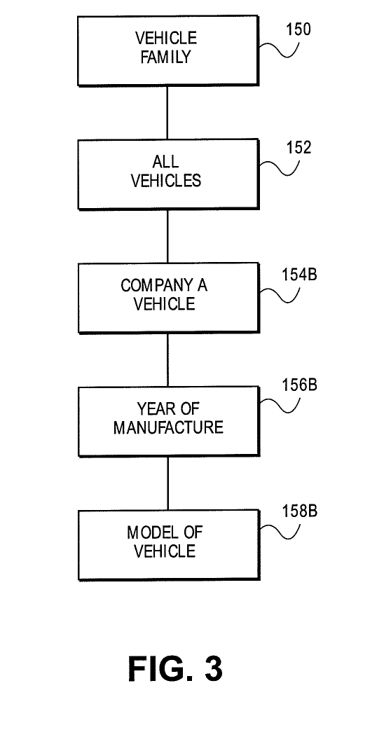

Referring to FIG. 3, as an example, the vehicle family tree 150 can be divided from the most generic, all vehicles 152, to vehicles grouped by company A 154B, then by the year of manufacture 156B, and then most specifically by the model of the vehicle 158B. Other groupings and set of hierarchical criteria can be set and this is shown only as an example.

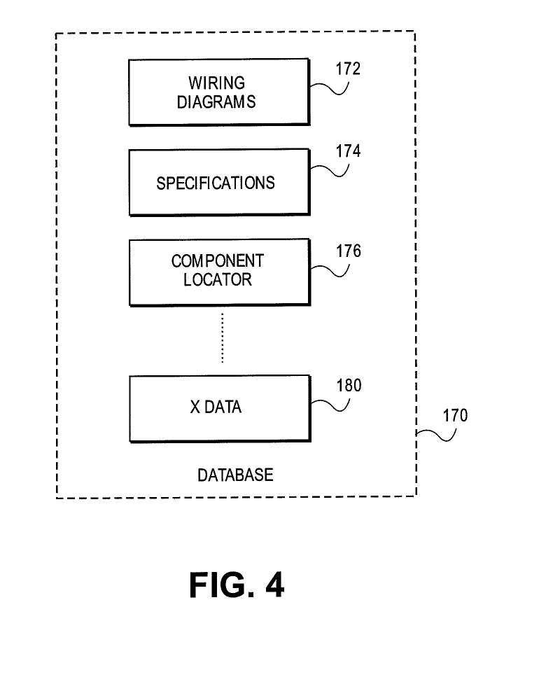

Referring to FIG. 4, the diagnostic equipment such as the computer 410 or the diagnostic tool 510 can include a database 170 in its memory for use by the diagnostic hierarchical system of the disclosure. The database 170 can include, for example, a registry for wiring diagrams 172, specifications 174, component locator 176, and may other registries holding data up to data “x” 180.

For example, the wiring diagrams 172, the specifications 174 and the component locator 176 can used to check the resistance of a battery cable or the resistance from a specific point A to a specific point B in the vehicle. The component locator 176 can be used to find a different example of the battery cable. The type of vehicle can be further divided by the model, type of engine, type of chassis, etc., with regard to determining the resistance.

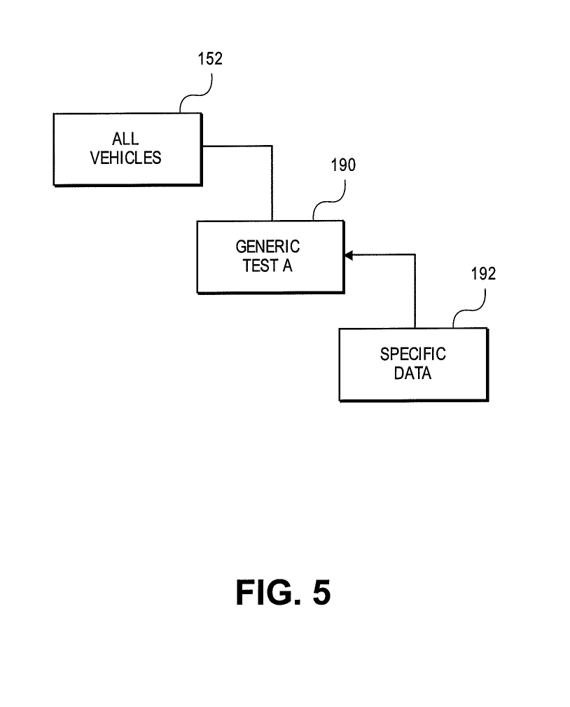

Referring to FIG. 5, the all vehicles 150 selection can further include, for example, generic test A 190. Generic test A, even though it is generic for all the vehicles, can made to be more effective and provide a specific result by inputting into the test specific data 192. The specific data 192 can be, for example, the test data for a specific model year and make of vehicle. Thereby, this makes the test even though it is generic into a smarter test, or a more specific test lending to a more customized result.

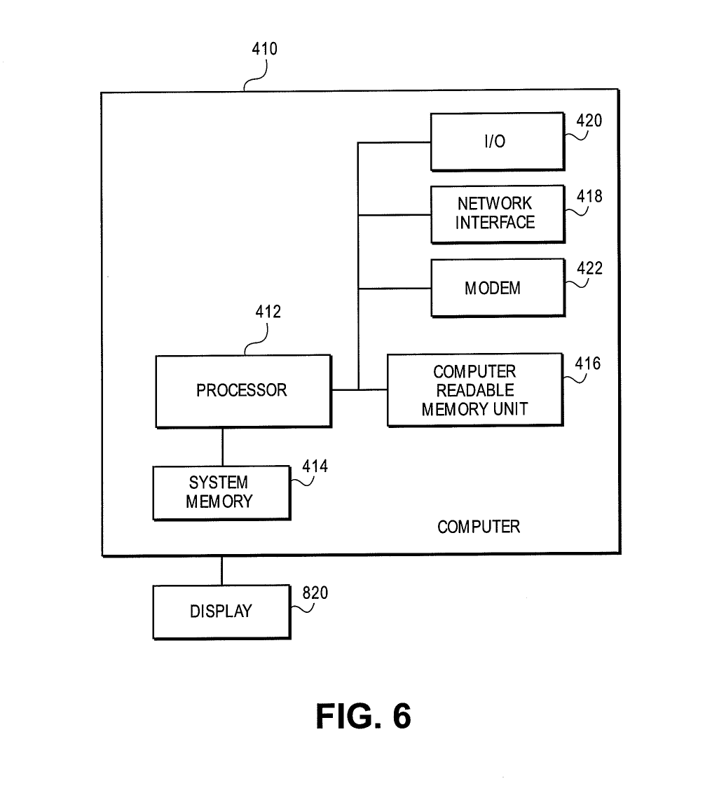

Referring to FIG. 6, an example of the computer 410 of FIG. 1, but not limited to this example of the computer 410, that can read computer readable media that includes computer-executable instructions of the disclosure. The computer 410 includes a processor 412 that uses the system memory 414 and a computer readable memory device 416 that includes certain computer readable recording media. A system bus 415 connects the processor 412 to a network interface 418, a modem 422 or other interface that accommodates a connection to another computer or network such as the Internet. The system bus may also include an input and output (I/O) interface 420 that accommodate connection to a variety of other devices. Furthermore, the computer 410 can output through, for example, the I/O 420, data for display on a display device 820.

The disclosure or parts thereof can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present disclosure can include the computer-readable medium having stored thereon a data structure including a plurality of fields containing data representing the techniques of the disclosure.

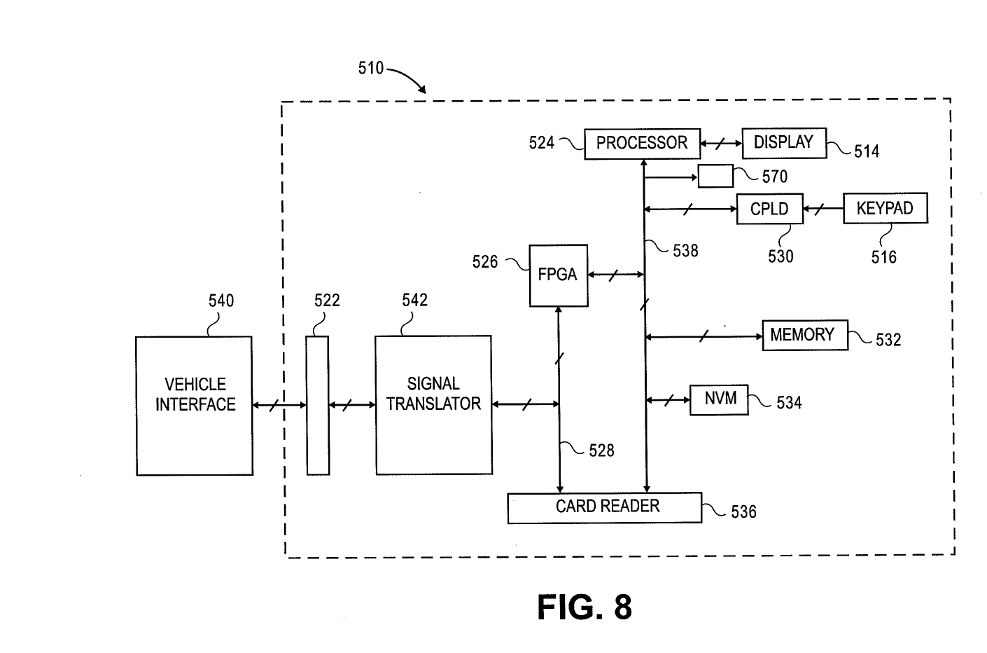

FIGS. 7-8 show the details of the diagnostic tool 510 of FIG. 1. Manufacturers have programmed their vehicle onboard computers with complicated methods of detecting a variety of problems. Further, the United States Environmental Protection Agency has mandated that DTCs be set where there are emissions related problems with the vehicle using the Onboard Diagnostic II System, also known as the OBD II system.

However, there are still problems of using the diagnostic tool since there are limitations in troubleshooting the actual cause of the functional anomaly of the diagnostic tool. A user is forced to look directly at the diagnostic tool's limited display that may display only the DTC or simple indicator of function being performed, and a message indicating a communication failure.

FIG. 7 is a front view illustrating a diagnostic tool 510 according to an embodiment of the disclosure. The diagnostic tool 510 can be any computing device, for example, the NEMISYS or GENISYS diagnostic tool from Service Solutions (part of the SPX Corporation) or other diagnostic tool. The diagnostic tool 510 includes a housing 512 to encase the various components of the diagnostic tool 510, such as a display 514, a user interface 516, a power button 518, a memory card reader 520 and a connector interface 522. The display 514 can be any type display, including, for example, but not limited to, a liquid crystal display (LCD), organic light emitting diode (OLED), field emission display (FED), electroluminescent display (ELD), etc. In addition, the LCD, for example, can be touch screen that both displays and performs the additional task of interfacing between the user and the diagnostic tool 510.

The user interface 516 allows the user to interact with the diagnostic tool 510, in order to operate the diagnostic tool as the user prefers. The user interface 516 can include function keys, arrow keys or any other type of keys that can manipulate the diagnostic tool 510 in order to operate the diagnostic tool through the software. The user interface or input device 516 can also be a mouse or any other suitable input device for the user interface 516, including a keypad, touchpad, etc. The user interface 516 can also include keys correlating to numbers or alphanumeric characters. Moreover, as mentioned above, when the display 514 is touch sensitive, the display 514 can supplement or even substitute for the user interface 516. The power key or button 518 allows the user to turn the power to the diagnostic tool 510 on and off, as required.

A memory card reader 520 can be a single type card reader, such as, but not limited to, a compact flash card, floppy disk, memory stick, secure digital, flash memory or other type of memory. The memory card reader 520 can be a reader that reads more than one of the aforementioned memory such as a combination memory card reader. Additionally, the card reader 520 can also read any other computer readable medium, such as CD (compact disc), DVD (digital video or versatile disc), etc.

The connector interface 522 allows the diagnostic tool 510 to connect to an external device, such as, but not limited to, an ECU (electronic control unit) of a vehicle, a computing device, an external communication device (such as a modem), a network, etc. through a wired or wireless connection. Connector interface 522 can also include connections such as a USB (universal serial bus), FIREWIRE (Institute of Electrical and Electronics Engineers (IEEE) 1394), modem, RS232, RS48J, and other connections to communicate with external devices, such as a hard drive, USB drive, CD player, DVD player, or other computer readable medium devices.

FIG. 8 is a block diagram of the components of a diagnostic tool 510. In FIG. 8, the diagnostic tool 10, according to an embodiment of the disclosure, includes a processor 524, a field programmable gate array (FPGA) 526, a first system bus 528, the display 514, a complex programmable logic device (CPLD) 530, the user interface 516 in the form of a keypad, a memory subsystem 532, an internal non-volatile memory (NVM) 534, a card reader 536, a second system bus 538, the connector interface 522, and a selectable signal translator 542. A vehicle communication interface 540 is in communication with the diagnostic tool 510 through connector interface 522 via an external cable. The connection between the vehicle communication interface 540 and the connector interface 522 can also be a wireless connection such as BLUETOOTH, infrared device, wireless fidelity (WiFi, e.g. 802.11), etc.

The selectable signal translator 542 communicates with the vehicle communication interface 540 through the connector interface 522. The signal translator 542 conditions signals received from a motor vehicle control unit through the vehicle communication interface 540 to a conditioned signal compatible with the diagnostic tool 510. The translator 542 can communicate with, for example, the communication protocols of J1850 signal, ISO 9141-2 signal, communication collision detection (CCD) (e.g., Chrysler collision detection), data communication links (DCL), serial communication interface (SCI), S/F codes, a solenoid drive, J1708, RS232, controller area network (CAN), or other communication protocols that are implemented in a vehicle.

The circuitry to translate a particular communication protocol can be selected by the FPGA 526 (e.g., by tri-stating unused transceivers) or by providing a keying device that plugs into the connector interface 522 that is provided by diagnostic tool 510 to connect diagnostic tool 510 to vehicle communication interface 540. Translator 542 is also coupled to FPGA 526 and the card reader 536 via the first system bus 528. FPGA 526 transmits to and receives signals (i.e., messages) from the motor vehicle control unit through the translator 542.

FPGA 526 is coupled to the processor 524 through various address, data and control lines by the second system bus 538. FPGA 526 is also coupled to the card reader 536 through the first system bus 528. Processor 524 is also coupled to the display 514 in order to output the desired information to the user. The processor 524 communicates with the CPLD 530 through the second system bus 538. Additionally, the processor 524 is programmed to receive input from the user through the user interface 516 via the CPLD 530. The CPLD 530 provides logic for decoding various inputs from the user of diagnostic tool 510 and also provides the glue-logic for various other interfacing tasks.

Memory subsystem 532 and internal non-volatile memory 534 are coupled to the second system bus 538, which allows for communication with the processor 524 and FPGA 526. Memory subsystem 532 can include an application dependent amount of dynamic random access memory (DRAM), a hard drive, and/or read only memory (ROM). Software to run the diagnostic tool 510 can be stored in the memory subsystem 532. The internal non-volatile memory 534 can be, but not limited to, an electrically erasable programmable read-only memory (EEPROM), flash ROM, or other similar memory. The internal non-volatile memory 534 can provide, for example, storage for boot code, self-diagnostics, various drivers and space for FPGA images, if desired. If less than all of the modules are implemented in FPGA 526, the non-volatile memory 534 can contain downloadable images so that FPGA 526 can be reconfigured for a different group of communication protocols.

Although an example of the hierarchical system of the disclosure is shown using a user limited configuration, it will be appreciated that other techniques for providing the configuration are available for a particular variable other than the type of user or the particular user. Also, the hierarchical system is useful to diagnose a vehicle and provide such information to the user in an efficient manner, taking into account the different configurations for the functions for any particular variable.

Therefore, the method and apparatus of the disclosure provides enhanced diagnostic hierarchy that eliminates the duplicates of diagnostic charts created by authors of diagnostic procedures. The method and apparatus of the disclosure also eliminates redundancy of data associated with diagnostic charts. The method and apparatus of the disclosure also reduces labor to create diagnostic scenarios. The method and apparatus of the disclosure also generalizes diagnostic charts associating them with diagnostic and vehicle families and sub-families. Further, the method and apparatus of disclosure avoids the complexity of lookup procedure during diagnostic runtime, etc.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A diagnostic tool for diagnosing a vehicle, comprising:
a signal translator that communicates with the vehicle in at least one protocol;
an input device that inputs information;
a processor that controls a software according to the input information from the input device and communicates with the vehicle with the signal translator, the processor controls a reception of diagnostic data of the vehicle through the signal translator, the processor receives a selected instruction of the diagnostic tool through the input device and correlates the desired instruction information with the information stored in a memory, the processor processes the received diagnostic data according to the selected instructions information according to a hierarchy stored on the memory;
the memory stores the software controlled by the processor, the memory stores a database of information for use by a hierarchical grouping of criteria and tests for diagnostics, the hierarchy including a first grouping and a second grouping, with each of the first and second grouping being further subdivided into additional sub-groupings, the selection of the diagnostic test being made according to the hierarchy from the most specific grouping to the most general grouping, and executing through the processor the selected diagnostic test according to the hierarchy; and
a display unit that receives and displays diagnostic information according to the selected stored and processed hierarchical information.

2. The diagnostic tool of claim 1, wherein the first grouping includes a diagnostic systems family and the second grouping includes a vehicle family, the diagnostic systems family being grouped by the diagnostic function and the vehicle family being grouped by the type of vehicle.

3. The diagnostic tool of claim 2, wherein the diagnostic systems family being subdivided into a plurality of symptoms.

4. The diagnostic tool of claim 3, wherein the symptoms being further subdivided into a plurality of tests.

5. The diagnostic tool of claim 3, wherein the symptoms being further subdivided into a plurality of failure mode tests according to a certain criteria.

6. The diagnostic tool of claim 1, wherein any child of the first and second grouping inherits the parents diagnostics unless a limitation is made.

7. The diagnostic tool of claim 6, wherein the inheritance from parent grouping of the first group to child grouping can be at least two levels of symptom based on when whole symptom diagnostics are overridden, and a failure mode test based when some of the failure tests can be overridden, inherited or hidden.

8. The diagnostic tool of claim 1, wherein the first grouping is linked with the second grouping for diagnostic hierarchy of the vehicle.

9. The diagnostic tool of claim 1, wherein the memory further comprising a volatile memory unit and a non-volatile memory unit, the non-volatile memory unit storing the hierarchy information.

10. The diagnostic tool of claim 1, wherein the processor accepts a selection of the hierarchy according to the inputted selection through the input device.

11. The diagnostic tool of claim 1, further comprising a housing encasing the signal translator, the input device, an input and output unit, the processor, the memory, and the display unit, for storing, processing and displaying the hierarchical information of a diagnostic procedure.

12. The diagnostic tool of claim 1, further comprising a connector interface that connects the signal translator with a vehicle interface through any one of a wired and wireless link to allow for recording of the diagnostic data between the diagnostic tool and the vehicle.

13. A method of operating a diagnostic tool for a vehicle, comprising:
linking the diagnostic tool with a diagnostic computer of the vehicle through a data link connector of the vehicle;
communicating with the diagnostic computer of the vehicle in a communication protocol;
receiving instruction with regard to a diagnostic procedure of the diagnostic tool;
correlating with the stored information according to a hierarchy;
grouping a first set of stored instructions into a first grouping;
grouping a second set of stored instructions into a second grouping;
subdividing the first and second grouping into a plurality of subgroups according to the hierarchy;
selecting from the most specific subgroup to the most general sub-group or group in determining the diagnostic test to be executed according to the hierarchy; and
processing the received diagnostic data according to the hierarchy for execution and display of the diagnostics.

14. The method of claim 13, wherein the step of grouping the first and second set of instructions, further comprised of the first grouping including a diagnostic systems family and the second grouping includes a vehicle family, the diagnostic systems family being grouped by the diagnostic function and the vehicle family being grouped by the type of vehicle.

15. The method of claim 13, wherein the diagnostic systems family being subdivided into a plurality of symptoms.

16. The method of claim 15, wherein the symptoms being further subdivided into a plurality of tests.

17. The method of claim 15, wherein the symptoms being further subdivided into a plurality of failure mode tests according to a certain criteria.

18. The method of claim 13, wherein any child of the first and second groupings inherits the parent's diagnostics unless a limitation is made.

19. The method of claim 18, wherein the inheritance from parent grouping of the first group to child grouping can be at least two levels of symptom based on when whole symptom diagnostics are overridden, and a failure mode test based when some of the failure tests can be overridden, inherited or hidden.

20. The method of claim 13, wherein the first grouping is linked with the second grouping for diagnostic hierarchy of the vehicle.

21. A diagnostic system for diagnosing a vehicle, comprising:
a signal translation means that communicates with the vehicle in at least one protocol;
an input means that inputs information;
a processor means that controls a software according to the input information from the input device and communicates with the vehicle with the signal translator means, the processor means controls a reception of diagnostic data of the vehicle through the signal translation means, the processor means receives a selected instruction of the diagnostic tool through the input means and correlates the desired instruction information with the information stored in a memory means, the processor means processes the received diagnostic data according to the selected instructions information according to a hierarchy stored on the memory;
the memory means stores the software controlled by the processor means, the memory means stores a database of information for use by a hierarchical grouping of criteria and tests for diagnostics, the hierarchy including a first grouping and a second grouping, with each of the first and second grouping being further subdivided into additional sub-groupings, the selection of the diagnostic test being made according to the hierarchy from the most specific grouping to the most general grouping, executing through the processor the selected diagnostic test according to the hierarchy; and
a display means that receives and displays diagnostic information according to the selected stored and processed hierarchical information.

22. The diagnostic system of claim 21, wherein the first grouping includes a diagnostic systems family and the second grouping includes a vehicle family, the diagnostic systems family being grouped by the diagnostic function and the vehicle family being grouped by the type of vehicle.

23. The diagnostic system of claim 22, wherein the diagnostic systems family being subdivided into a plurality of symptoms.

24. The diagnostic tool of claim 23, wherein the symptoms being further subdivided into a plurality of failure mode tests according to a certain criteria.

25. The diagnostic system of claim 21, wherein:
any child of the first and second grouping inherits the parents diagnostics unless a limitation is made,
the inheritance from parent grouping of the first group to child grouping can be at least two levels of symptom based on when whole symptom diagnostics are overridden, and a failure mode test based when some of the failure tests can be overridden, inherited or hidden, and
the first grouping is linked with the second grouping for diagnostic hierarchy of the vehicle.
